(19) United States
(12) Patent Application Publication
(10) Pub. No.: US 2013/0041703 A1
(43) Pub. Date: Feb. 14, 2013

(54) SYSTEM AND METHOD FOR MANAGING IMMIGRATION STATUS

(71) Applicants: Kishore K. GANJI, Manalapan, NJ (US); Robert E. Markowitz, Glen Rock, NJ (US); Kanan Alpesh Mehta, Piscataway, NJ (US); Ravi Shankar Vadla, Edison, NJ (US); Sridhar Chary Vadla, Ranga Reddy (IN)

(72) Inventors: Kishore K. GANJI, Manalapan, NJ (US); Robert E. Markowitz, Glen Rock, NJ (US); Kanan Alpesh Mehta, Piscataway, NJ (US); Ravi Shankar Vadla, Edison, NJ (US); Sridhar Chary Vadla, Ranga Reddy (IN)

(73) Assignee: HubEntry LLC, South Plainfield, NJ (US)

(21) Appl. No.: 13/205,276

(22) Filed: Aug. 8, 2011

(51) Int. Cl. G06Q 10/00

(52) U.S. Cl. 705/7.11

(57) ABSTRACT

Disclosed herein are systems, methods, and non-transitory computer-readable storage media for managing immigration status. A system configured to practice the method identifies a project, such as a work contract. The system identifies a worker assigned to the project, wherein an immigration status of the worker requires the worker to have a visa, such as an H-1B visa, to participate in the project. The system electronically prepares and tracks immigration documentation associated with the visa in order to allow the worker to participate in the project. Then the system determines if an event occurs that impacts the immigration status, and, if the event occurs, the system updates the immigration documentation based on the event. The immigration documentation can include a labor condition application (LCA) and/or a public access file (PAF). The system can prepare the immigration documentation based on information stored in a personal profile of the worker.

### BACKGROUND

1. Technical Field

The present disclosure relates to managing immigration status and more specifically to automatically handling and coordinating various requirements for specific workers and projects for which immigration status is an important regulation compliance concern.

2. Introduction

Many employers hire foreign workers as specialists to work on specific projects. However, the 1990 Immigration Act and other laws impose a myriad of complex and potentially confusing requirements on employers of such foreign workers. Immigration compliance is unfortunately a necessary but burdensome part of hiring foreign workers. Immigration compliance officers of the employer must gather a burdensome amount of data, fill out and file the appropriate paperwork, track immigration related deadlines, and so forth. This additional effort causes increased overhead for the employer. While this overhead may be negligible for a single foreign employee, the overhead can become a serious responsibility when managing tens, hundreds, or more foreign employees. Failure to follow immigration laws can lead to civil liability, criminal liability, and/or monetary fines for the employer. While foreign specialist workers can bring significant benefits of expert skill and knowledge, the paperwork and administrative overhead involved is an obstacle.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The 1990 Immigration Act imposed the requirement of a labor condition application (LCA) for hiring foreign workers. The employer must make specific representations regarding the conditions under which the foreign worker was hired and will be employed, including that the employer will pay the required wage, which is the greater of the prevailing wage or the actual wage paid to other employees in the same position, that the employment of H-1B workers will not adversely effect the working conditions of US workers, that when the LCA was filed, there was no strike, lockout or other work stoppage because of a labor dispute, and that the H-1B worker will be given a copy of the LCA, and the employer has notified the bargaining representative if the job is unionized, or if not, has posted in a conspicuous place notice that an LCA was filed. The legislature added several requirements in 1998 relating to “H-1B dependent” employers. Whether an employer is H-1B dependent depends on a percentage or amount of the workforce made up of H-1B visa holders if the employer has over 50 employees.

Also, H-1B dependent employers are not subject to the new requirements when they are filing an LCA that covers only “exempt” H-1B workers. Exempt workers are those who are paid at least $60,000 annually or who have obtained a master's degree or higher in a field related to the intended employment. If the employer is H-1B dependent, the employer must attest (swear under oath) that it has not and will not “displace” a US worker during the period from 90 days before the H-1B petition is filed until 90 days after it has been filed, and attest that it has taken “good faith steps” to recruit US workers for the job, and that they have offered it to any US worker who applied that was at least as qualified as the H-1B nonimmigrant.

Once the LCA has been filled out, the employer submits the LCA to the United States Department of Labor (DOL). The DOL certifies the LCA within seven days of submission. Within one business day of filing the LCA, the employer must establish a public access file (PAF) that may be viewed by any person. The PAF must include a copy of the LCA, a statement of the actual wage received by the H-1B worker, the prevailing wage, including its source, whether the state or a private survey is used, a memo from the employer explaining the actual wage determination, and evidence that the LCA has been filed. In addition, the employer must keep other information that need not be made available to the public. This includes payroll data for all employees in the same occupations as the H-1B worker, a calculation of the actual wage paid the H-1B worker, the raw data behind the prevailing wage determination, documentation of any fringe benefits provided workers, and evidence that the H-1B worker has been given a copy of the LCA. Once approved, an LCA is valid for three years.

Disclosed are systems, methods, and non-transitory computer-readable storage media for managing immigration status according to these immigration guidelines and can be adapted within the spirit and scope of this disclosure to comply with amendments and other changes to these laws. The principles disclosed herein can also incorporate and implement company or organization specific rules and guidelines for hiring foreign workers. A system configured to practice the method identifies a project, such as a work contract. The system identifies a worker assigned to the project, wherein an immigration status of the worker requires the worker to have a visa, such as an H-1B visa, to participate in the project. The system electronically prepares and tracks immigration documentation associated with the visa in order to allow the worker to participate in the project. The immigration documentation can include a labor condition application (LCA) and/or a public access file (PAF). The system can prepare the immigration documentation based on information stored in a personal profile of the worker. The system can track the immigration documentation by electronically communicating with a government immigration server via a direct wired or wireless connection and/or a network connection such as the Internet. As part of preparing and tracking the immigration documentation, the system can receive an electronic signature from the worker or retrieve the electronic signature from a database of previously provided electronic signatures. Then the system can apply the electronic signature to the immigration documentation. The electronic signature can take the form of a cryptographic signature, user-entered text representing an actual signature, a scanned image of an actual signature, or any other suitable signature format. When processing immigration documents that require wage information, the system can retrieve wage information for the worker while participating in the project and incorporate that wage information into the immigration documentation. For example, the system can retrieve the wage information from a description or specification document describing the project, from data manually entered by a user such as a supervisor or human resources agent, or from other immigration documentation associated with similar projects and/or from on-line databases.

Further, the system can automatically fill out at least part of the immigration documentation to generate proposed immigration documentation, and display the proposed immigration documentation to a user, such as a Human Resources representative and/or the worker. The user can optionally edit the proposed immigration documentation to correct information which is wrong or to add information which is missing before approving the proposed immigration documentation. When the user enters or corrects information in the proposed immigration documentation, the system can automatically incorporate those changes and updates into a user profile associated with the worker and/or the project. As edits or revisions are entered to the immigration documents, the system can record a time stamp or a history of revisions. The system can also record time stamps of when official or final versions of the documents are filed.

Then the system determines if an event occurs that impacts the immigration status, such as cancellation of the project, a project milestone, attendance of the worker, events indicated by a timesheet of the worker, or a contribution to the project by the worker, and, if the event occurs, the system updates the immigration documentation based on the event. The system can determine if the event occurs based on user-entered information and/or government-provided information.

In order to maintain some level of continuity across projects, the system can generate, fetch, update, and/or reuse a worker profile associated with the worker and link the worker profile to the project. The worker profile can be linked to multiple projects simultaneously and/or over time. A worker profile can be dormant, i.e. not linked to any active project.

The system can track and report progress of existing immigration documents, projects, and/or workers. The system can generate a report based on at least one of the worker, the project, and the immigration status, wherein the report is in a row and column format such as a spreadsheet. Further, the system can color code entries in the report to indicate a current status of the entries, so that entries that have no problems are green, entries with minor problems, entries that require a minor task, or entries with deadlines far in the future are yellow, and entries with critical problems, past-due or otherwise urgent deadlines are red. The meaning of the colors can vary based on the type of entry with which the color is associated. The system can also provide notifications, such as an email, a text message, a printed notification, a sound, an audio message, a video message, or an on-screen notification, of deadlines by identifying an impending deadline associated with the immigration documentation, and then sending a notification reminder of the impending deadline to a user.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates an example system architecture;

FIGS. 3-17 illustrates exemplary user interfaces for various portions of a software program for managing immigration status; and

FIG. 18 illustrates an example method embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

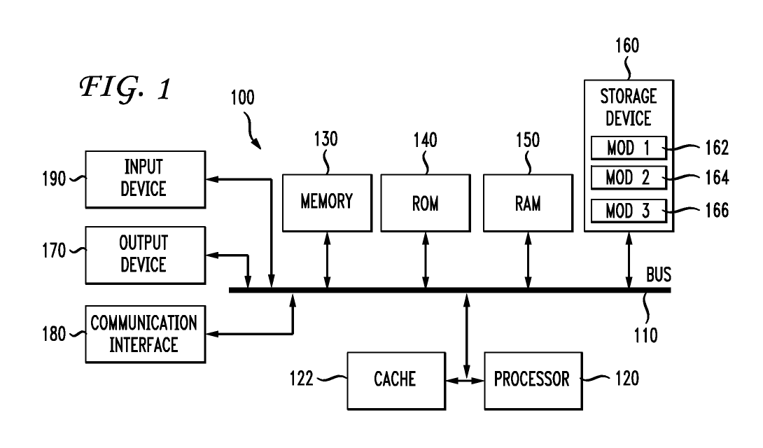

The present disclosure addresses the need in the art for improving the handling of immigration status of workers. A system, method and non-transitory computer-readable media are disclosed which provide automated immigration status management. A brief introductory description of a basic general purpose system or computing device in FIG. 1 which can be employed to practice the concepts is disclosed herein. Variations and example user interfaces shall be discussed herein as the various embodiments are set forth. The disclosure now turns to FIG. 1.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

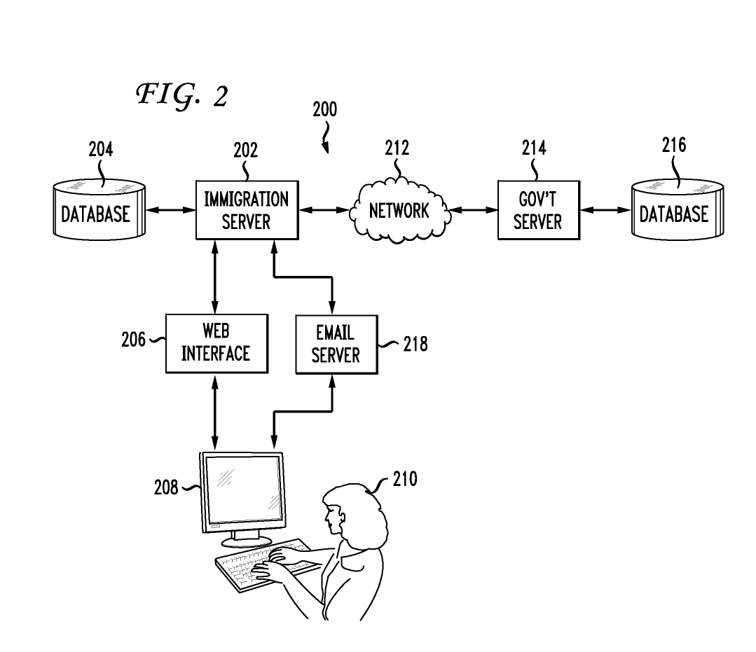

Having disclosed some components of a computing system, the disclosure now returns to a discussion of tracking and managing immigration status of workers associated with projects. FIG. 2 illustrates an example system architecture 200 for tracking and managing immigration status. In this architecture, an immigration server 202 can be a single or multiple computing devices that process requests for immigration information using a database 204 of information about user profiles, immigration laws, immigration procedures, visa requirements, rules, company policies, and other data relevant to individual users, projects, or immigration documents. The immigration server 202 can provide a public and/or private application programming interface to allow users, through software programs, to access functionality of the immigration server 202. The immigration server 202 can optionally incorporate or interact with a web interface 206 to provide users 210 access to the immigration server 202 via client computing devices 208. The immigration server 202 can sync portions of the government database 216 to its local database 204. Then the immigration server 202 can make that information available for viewing, editing, deletion, or other management purposes via the web interface 206 to the client devices 208. In one example, the immigration server 202 sends notifications of immigration related deadlines to the client device 208 via an email server 218 or similar service such as a Short Message Service (SMS) server. Other variations of this architecture accomplishing similar functionality can be used as well, including a cluster computing architecture, a local computing client architecture, a thin-client architecture, and so forth.

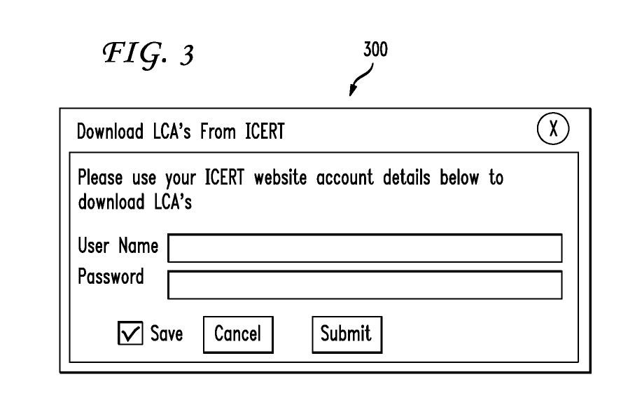

FIGS. 3-17 illustrates exemplary user interfaces for various portions of a software program implemented using at least part of the exemplary architecture 200 for managing immigration status. The software program can be implemented as a client-side software program or, as shown here, as a server-side software program accessible via a web interface. FIG. 3 illustrates an exemplary login window 300 for a user to authenticate and access the software program. The login window 300 can be replaced with other suitable authentication portals. Other suitable authentication mechanisms can substitute for the user credentials, such as biometric authentication or a physical security token. The type of the user logging in can influence the type of pages available and the information displayed thereon. The example user interfaces discussed herein are shown from the point of view of an administrator, but when a user with lesser privileges logs in the system displays a subset of the entire available information and/or functionality based on permissions associated with that user.

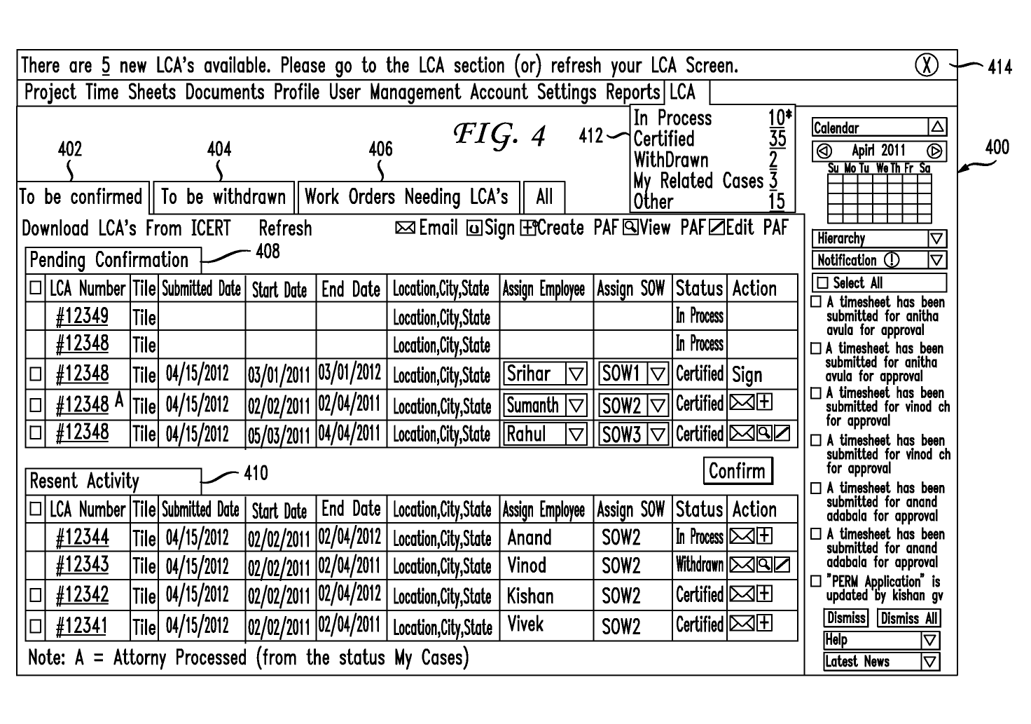

FIG. 4 illustrates an initial staging or management interface 400 that the system can display to the user after the user has logged in. This interface 400 can include any or all of the described elements as well as other elements not shown. The interface 400 can include a tab 402 for labor condition applications (LCAs) to be confirmed, a tab 404 for LCAs to be withdrawn, and a tab 406 for work orders that need an LCA. This example interface 400 is in a default or initial mode where information associated with tab 402 is displayed. Information associated with tab 402 can include LCAs pending confirmation 408 as well as recent activity 410 concerning specific LCAs. Further, the user can download LCAs via this interface. Other elements shown in this example interface 400 include a calendar, a hierarchy, and notifications. This interface 400 can also include a summary view 412 of overall LCA status for an organization, showing how many LCAs are at each stage. The interface can also provide an active notification 414 of LCA matters that require attention, such as new LCAs or LCAs that are approaching or past a deadline date. The summary view 412 can color code specific entries, provide icons, or incorporate hover-over tooltips (such as via JavaScript) to indicate a status of an LCA.

The system can track projects, milestones, time and attendance of employees, passport information, scanned documents, and other relevant data generated within the company. Further, the system can automatically retrieve data from government sources, such as government websites or databases. The system can then automate assignments of LCA documents, track the status of LCA documents, and handle all the assignments associated with LCA documents with respect to the employee and with respect to the immigration office.

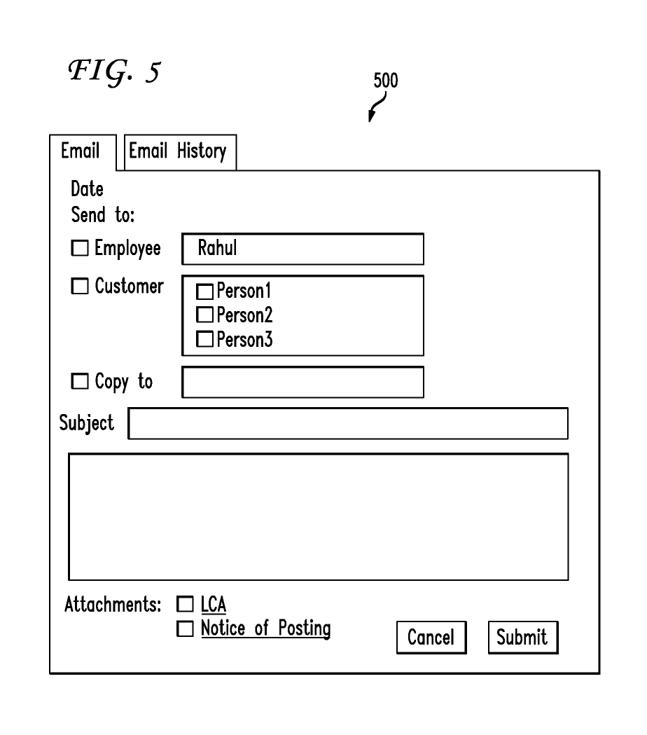

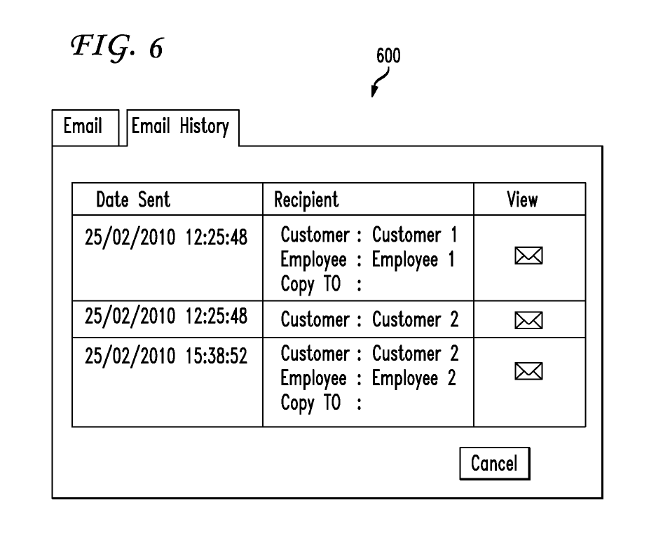

The user can take specific actions for an LCA directly in this interface. For example, the user can click on the email icon under the Actions column in the pending confirmation table 408 to send a confirmation email. FIG. 5 illustrates an example popup window 500 responsive to clicking on the email icon. This form can be completely or partially prepopulated with attachments, recipients, carbon-copy recipients, blind carbon copy recipients, subject line, body text, reference numbers, message priority, and so forth. The popup window 500 can also include an email history tab. FIG. 6 illustrates a popup window 600 after the email history tab has been clicked. The email history can show a summary view of emails sent and/or received regarding a particular LCA, as well as provide a way to view the actual email messages. The user can take other actions via the interface shown in FIG. 4 as well, such as viewing a file history, viewing documents, signing documents, and so forth.

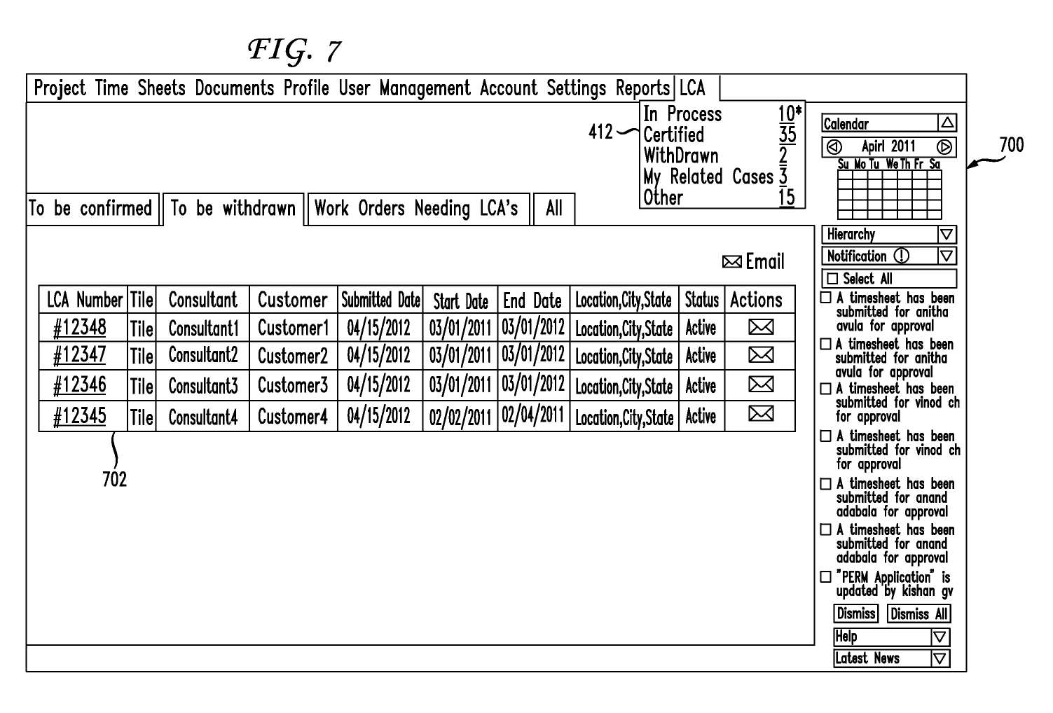

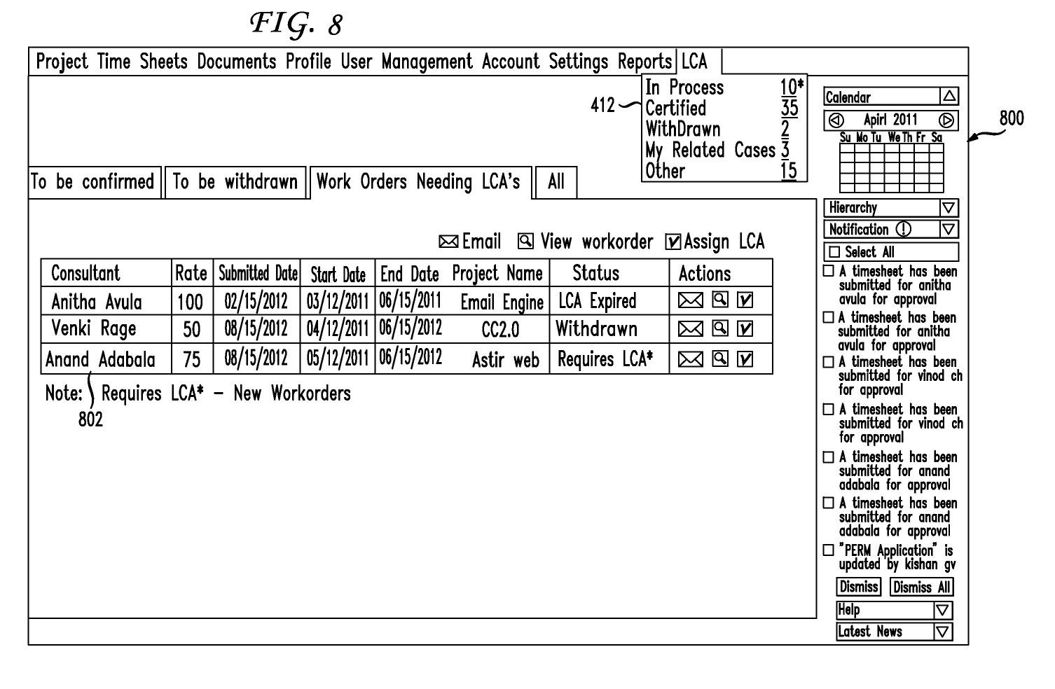

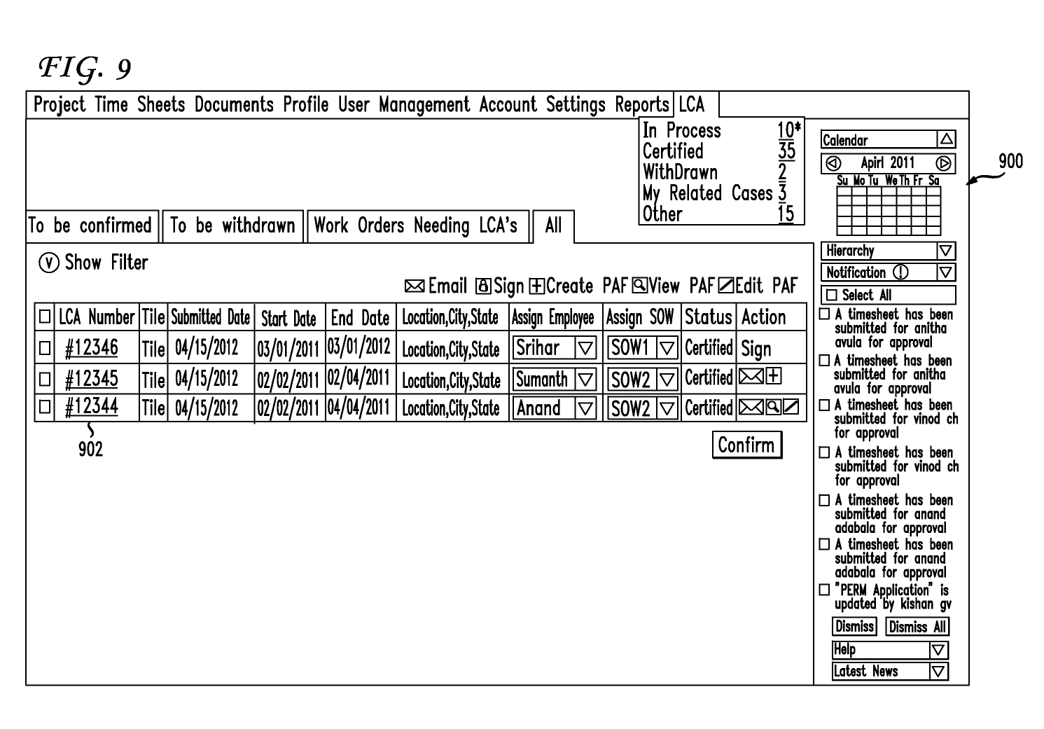

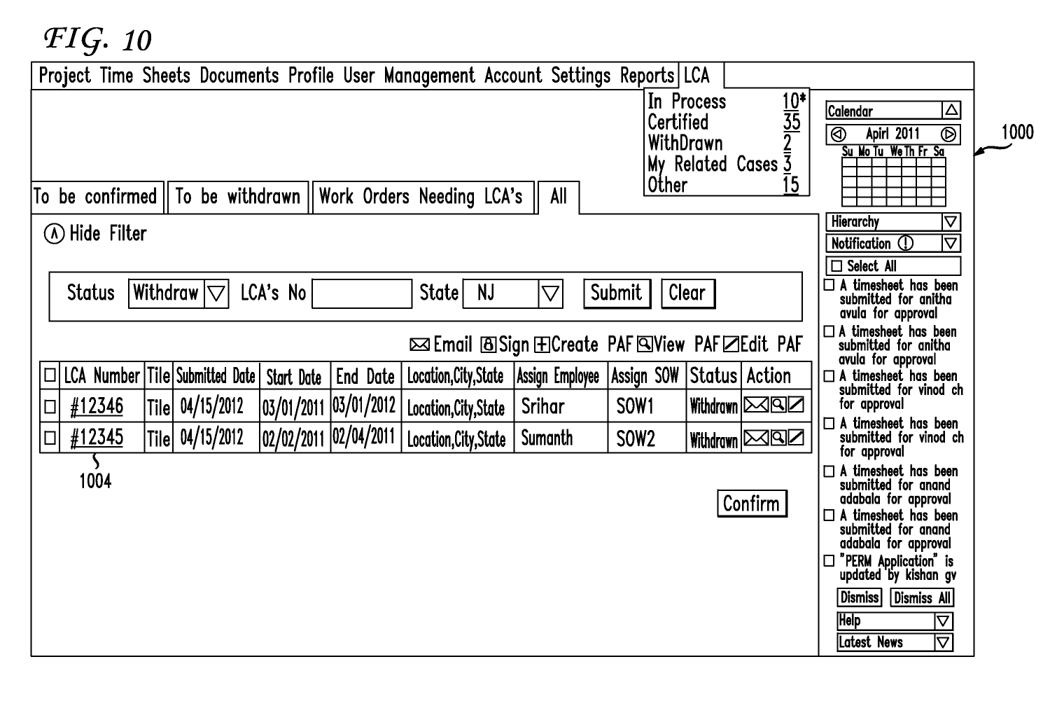

FIG. 7 illustrates the management interface 700 after selecting tab 404 for LCAs to be withdrawn. This interface 700 includes a table 702 showing LCAs that should be withdrawn, and actions to take with regards to those LCAs. The system can periodically retrieve status updates of LCAs to discover when the government changes the status of a particular LCA to withdrawn. Then the system can pull down the differentials, remove that LCA from the main list, move it to the “to be withdrawn” list and automatically perform any other necessary steps, up to and including automatically notifying the user that the LCA needs to be withdrawn. When the LCA is in the Withdrawn status and the system receives notification thereof, the system changes the status to Withdrawn and moves the LCA from the “to be withdrawn” list to the “All LCA's” list. FIG. 8 illustrates the management interface 800 after selecting tab 406 for work orders needing an LCA. This interface 800 includes a table 802 showing outstanding work orders that need an LCA. The table 802 can indicate a reason or status for each outstanding work order. For example, a work order may require an LCA because it is a new work order, or because a previous LCA expired or had been withdrawn. FIG. 9 illustrates the management interface 900 after selecting a tab showing all cases related to a particular user, such as the user that has logged in to the interface. This interface 900 can include a table 902 showing the related cases, including a current status of each, actions to be taken, a history of the related cases, and so forth. FIG. 10 illustrates the management interface 1000 that makes use of a filter 1002. The user can select one or more filter 1002, such as a particular status, a keyword, an employer, an employee, and so forth. Then the system can update or present a table 1004 of results according to the filter. In this example, table 1004 shows only withdrawn LCAs.

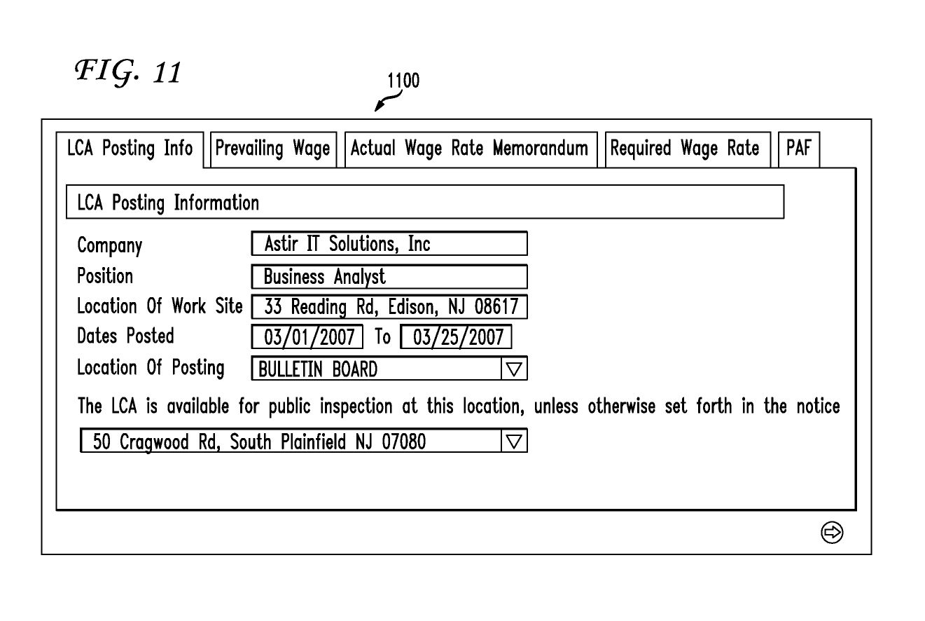

The disclosure turns now to a discussion of public access files (PAFs). Employers must maintain a PAF at the employer's principal place of business. The PAF must be available for inspection by any individual or the United States Department of Labor. The PAF must contain a copy of the signed and certified LCA, statement of the actual wage to be paid to the H-1B worker, the prevailing wage determination, memorandum explaining the actual wage calculation, summary of benefits offered to similarly employed U.S. workers, copy of the posting notice/s, and evidence that a copy of the LCA was given to the H-1B worker. The system can automate these requirements as well as other functionality related to PAFs. FIG. 11 illustrates a first portion of an example PAF user interface 1100. This interface 1100 can automatically populate information such as the company, position, employee title, location of the work site from the LCA and/or other sources such as a corporate directory or a human resources database to ensure that the information is accurate and in compliance with government regulations and company/project policies. This approach also saves significant manual labor and time spent preparing this documentation. Further, this interface 1100 can include user selectable and editable options such as the dates posted, location of a publicly available electronic posting, and the location of the publicly available physical documents. The location may not store the actual physical documents, but simply be a location where, upon request, the documents may be printed.

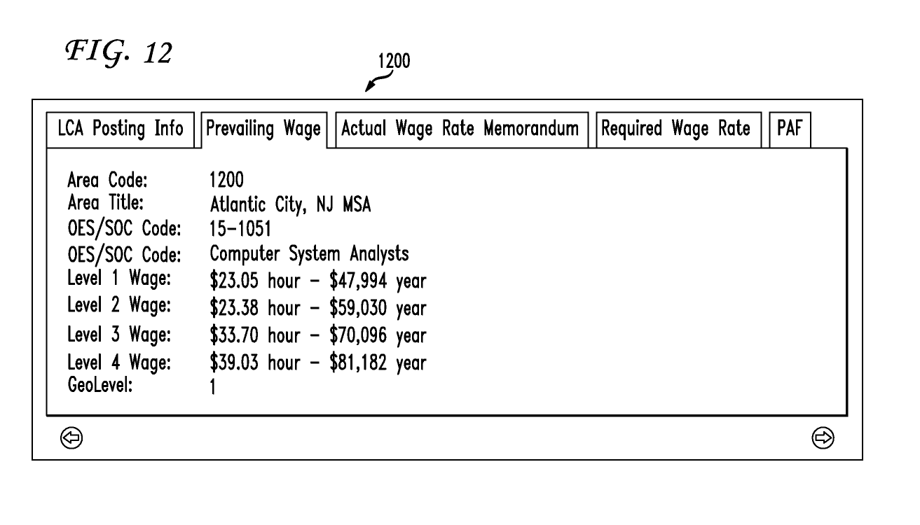

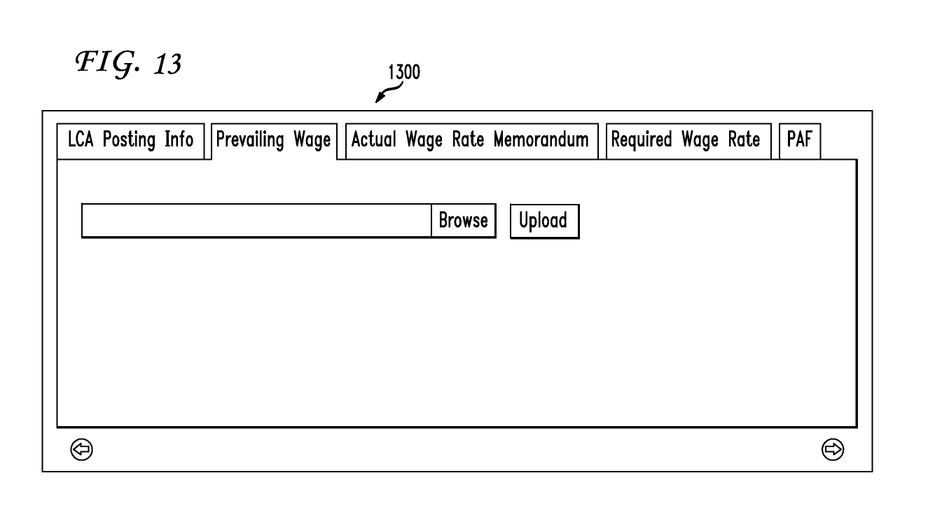

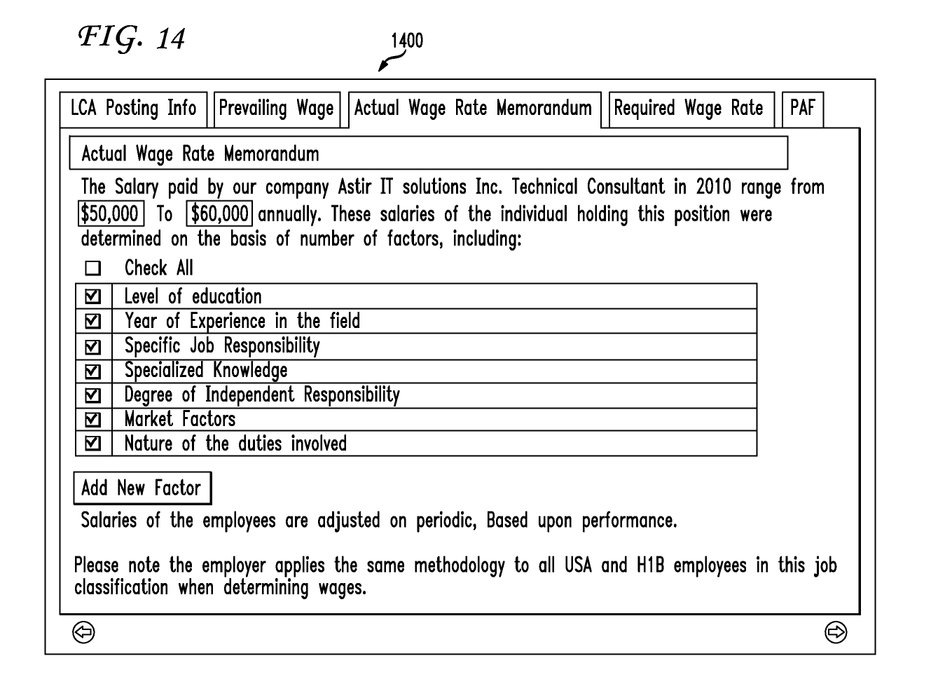

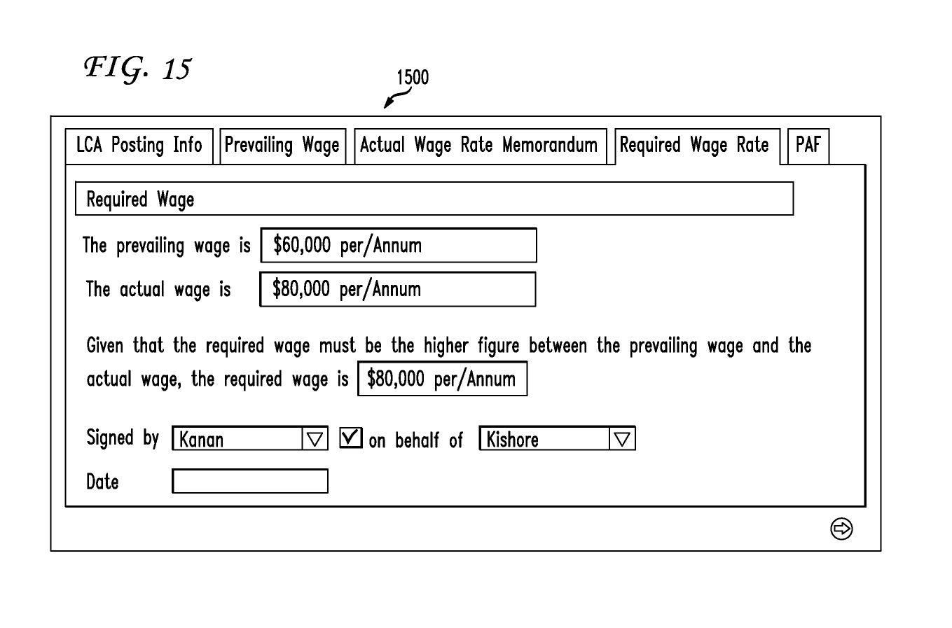

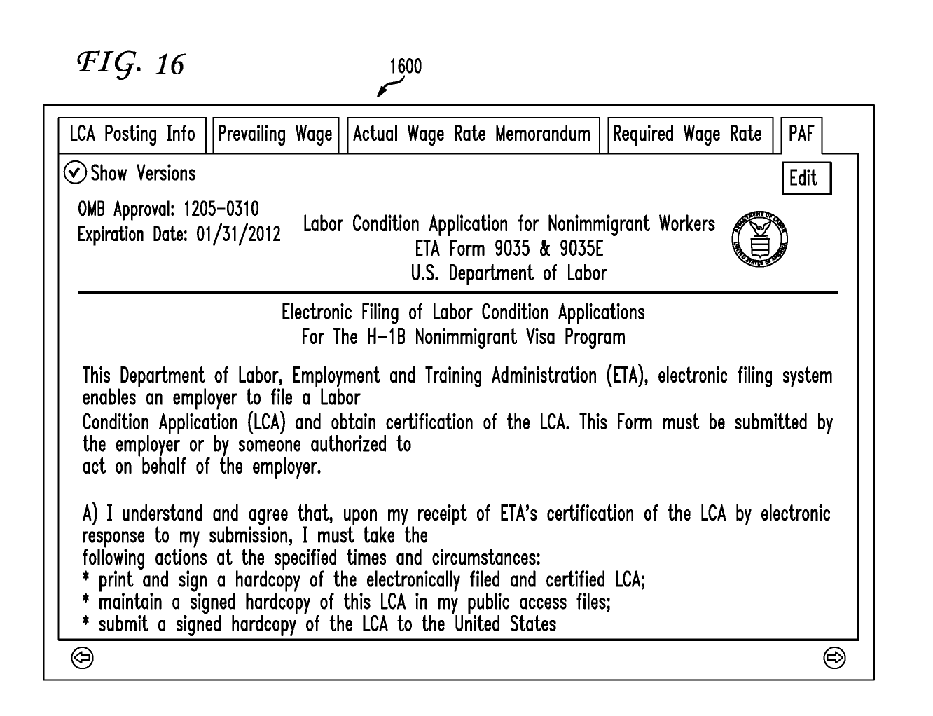

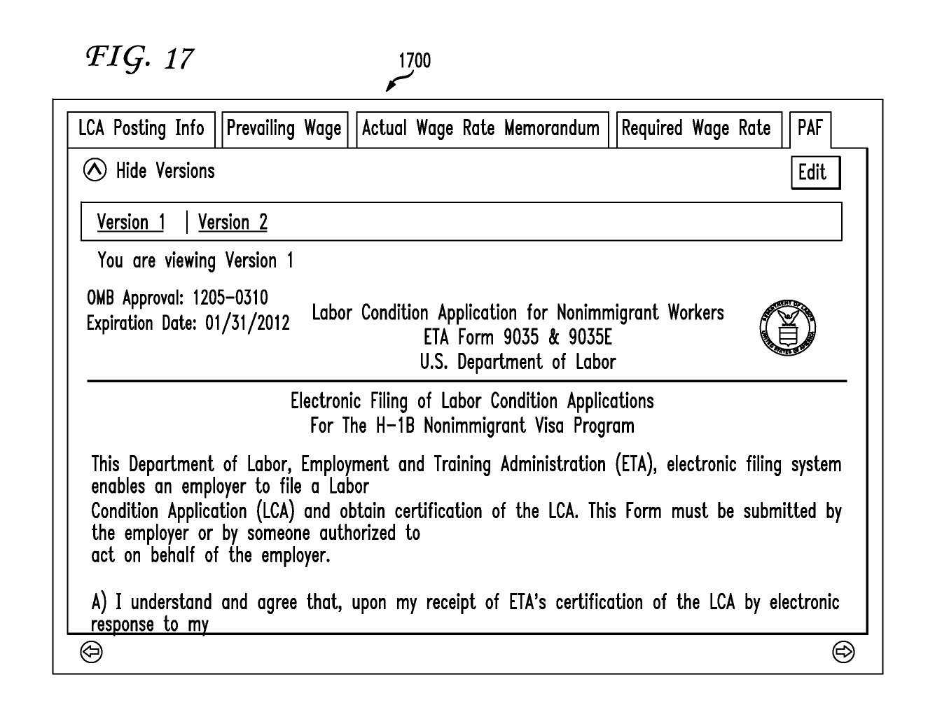

FIG. 12 illustrates a second portion of an example PAF user interface 1200. This interface 1200 shows the prevailing wage information for the task to which the foreign employee is or will be assigned. This information is shown as being fixed and prepopulated, but the interface 1200 can provide a mechanism for a user to provide manual corrections or updates. FIG. 13 illustrates an alternative second portion of an example PAF user interface 1300. This interface 1300 allows a user to provide prevailing wage information by uploading a file. This interface can also include other user input elements for entering wage information manually, such as textboxes, sliders, checkboxes, and number pickers. FIG. 14 illustrates a third portion of an example PAF user interface 1400. This interface 1400 illustrates actual wage rate information. This information can be automatically populated and/or manually entered by a user. FIG. 15 illustrates a fourth portion of an example PAF user interface 1500. This interface 1500 demonstrates the reasoning for selecting the proper wage using the previously retrieved and/or entered wage information based on guidelines established in the immigration laws. Further, this interface 1500 can include a section for a supervisor, human resources representative, employee, or other authorized user to sign to approve the wage rate. FIG. 16 illustrates a fifth portion of an example PAF user interface 1600. This interface 1600 displays a current version of the PAF in electronic form. The interface 1600 can allow a user to edit, download, or print the PAF. FIG. 17 illustrates another view of the fifth portion of an example PAF user interface 1700. This interface 1700 provides easy access to multiple versions of the PAF, such as previous or alternate versions. The system can prevent the user from making changes to previous versions to preserve the integrity of the records. However, the system can allow a user to make changes to a previous version and save them as a separate document, for example.

The system can receive uploaded supporting documents and provide access to uploaded documents. The system can make documents available publicly via an online bulletin board, upon request, and/or via a printed publication. The system can automatically track the timing of filings, requests, and public availability for compliance reporting purposes.

The interfaces and systems disclosed herein can be adapted for use with mobile devices. Further, the system can incorporate social media to populate and/or update certain pieces of information which are missing or which may be stale. The system can incorporate social connections into an employee profile to keep specific individuals, groups of individuals, or types of individuals on a same project or team or apart from each other.

The system can actively look for jobs or task openings and provide suggestions to a user for how to handle immigration status issues for potential candidates for those jobs or tasks. Further, the system can try to match a database of potential foreign employees to an open job or task to make hiring suggestions or recommendations, including any pertinent immigration status related issues. The system can also incorporate advertising and/or corporate branding into the user interface, public postings, and/or automatically generated correspondence. An immigration status management service of this type can be offered as software-as-a-service on a subscription basis, or can be offered on a per-person or per-transaction basis.

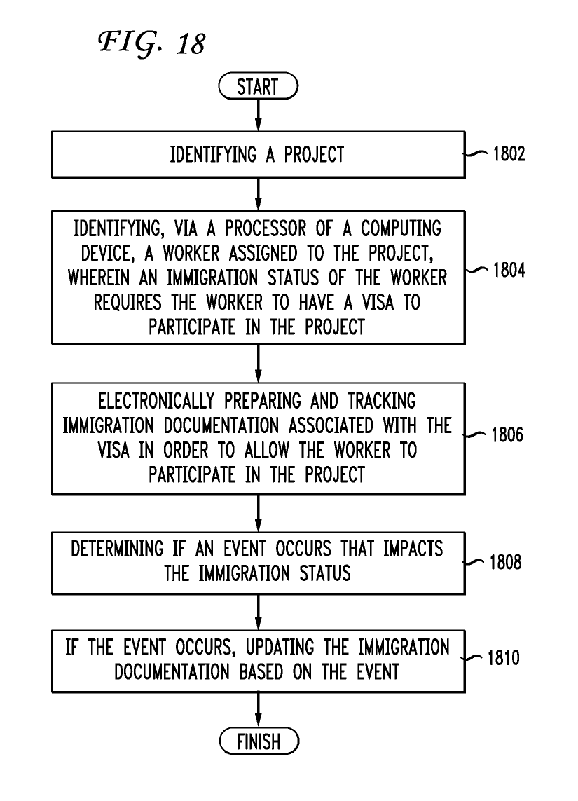

Having disclosed some basic system components, exemplary user interfaces, and concepts, the disclosure now turns to the exemplary method embodiment shown in FIG. 18. For the sake of clarity, the method is discussed in terms of an exemplary system 100 as shown in FIG. 1 configured to practice the method. The steps outlined herein are exemplary and can be implemented in any combination thereof, including combinations that exclude, add, or modify certain steps.

The system 100 identifies a project, such as a work contract (1802) and identifies a worker assigned to the project (1804), wherein an immigration status of the worker requires the worker to have a visa, such as an H-1B visa, to participate in the project. The system electronically prepares and tracks documentation associated with the visa in order to allow the worker to participate in the project (1806). The immigration documentation can include a labor condition application (LCA) and/or a public access file (PAF). The system can prepare the immigration documentation based on information stored in a personal profile of the worker. The system can automatically file the immigration documentation by electronically communicating with a government immigration server via a direct wired or wireless connection and/or a network connection such as the Internet. As part of preparing the immigration documentation, the system can receive an electronic signature from the worker or retrieve the electronic signature from a database of previously provided electronic signatures. Then the system can apply the electronic signature to the immigration documentation. The electronic signature can take the form of a cryptographic signature, user-entered text representing an actual signature, a scanned image of an actual signature, or any other suitable signature format. When processing immigration documents that require wage information, the system can retrieve wage information for the worker while participating in the project and incorporate that wage information into the immigration documentation. For example, the system can retrieve the wage information from a description or specification document describing the project, from data manually entered by a user such as a supervisor or human resources agent, or from other immigration documentation associated with similar projects.

Further, the system can automatically fill out at least part of the immigration documentation to generate proposed immigration documentation, and display the proposed immigration documentation to a user, such as a Human Resources representative and/or the worker. Then, upon receiving approval from the user of the proposed immigration documentation, the system can electronically sign the proposed immigration documentation. The user can optionally edit the proposed immigration documentation to correct information which is wrong or to add information which is missing before approving the proposed immigration documentation. When the user enters or corrects information in the proposed immigration documentation, the system can automatically incorporate those changes and updates into a user profile associated with the worker and/or the project. As edits or revisions are entered to the immigration documents, the system can record a time stamp or a history of revisions. The system can also record time stamps of when official or final versions of the documents are edited.

Then the system determines if an event occurs that impacts the immigration status (1808), such as cancellation of the project, a project milestone, attendance of the worker, events indicated by a timesheet of the worker, or a contribution to the project by the worker, and, if the event occurs, the system updates the immigration documentation based on the event (1810). The system can determine if the event occurs based on user-entered information and/or government-provided information.

In order to maintain some level of continuity across projects, the system can generate, fetch, update, and/or reuse a worker profile associated with the worker and link the worker profile to the project. The worker profile can be linked to multiple projects simultaneously and/or over time. A worker profile can be dormant, i.e. not linked to any active project.

The system can track and report progress of existing immigration documents, projects, and/or workers. The system can generate a report based on at least one of the worker, the project, and the immigration status, wherein the report is in a row and column format such as a spreadsheet. Further, the system can color code entries in the report to indicate a current status of the entries, so that entries that have no problems are green, entries with minor problems, entries that require a minor task, or entries with deadlines far in the future are yellow, and entries with critical problems, past-due or otherwise urgent deadlines are red. The meaning of the colors can vary based on the type of entry with which the color is associated. The system can also provide notifications, such as an email, a text message, a printed notification, a sound, an audio message, a video message, or an on-screen notification, of deadlines by identifying an impending deadline associated with the immigration documentation, and then sending a notification reminder of the impending deadline to a user.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A method comprising:
identifying a project;
identifying, via a processor of a computing device, a worker assigned to the project, wherein an immigration status of the worker requires the worker to have a visa to participate in the project;
electronically preparing and tracking immigration documentation associated with the visa in order to allow the worker to participate in the project;
determining if an event occurs that impacts the immigration status; and
if the event occurs, updating the immigration documentation based on the event.

2. The method of claim 1, wherein the visa is an H-1B visa.

3. The method of claim 1, wherein the immigration documentation comprises at least one of a labor condition application and a public access file.

4. The method of claim 1, wherein the event comprises at least one of cancellation of the project, a project milestone, attendance of the worker, a timesheet of the worker, and a contribution to the project by the worker.

5. The method of claim 1, wherein electronically preparing the immigration documentation is based on information stored in a personal profile of the worker.

6. The method of claim 1, wherein filing the immigration documentation comprises electronic communications with a government immigration server.

7. The method of claim 1, wherein determining if the event occurs is based on at least one of user-entered information and government-provided information.

8. The method of claim 1, further comprising:
generating a worker profile associated with the worker; and
linking the worker profile to the project.

9. The method of claim 8, wherein the worker profile is linked to multiple projects associated with the worker.

10. The method of claim 1, further comprising generating a report based on at least one of the worker, the project, and the immigration status, wherein the report is in a row and column format.

11. The method of claim 10, wherein the report color codes entries in the report to indicate a current status of the entries.

12. The method of claim 1, wherein electronically preparing, signing and tracking the immigration documentation further comprises:
automatically filling out at least part of the immigration documentation to yield proposed immigration documentation;
displaying the proposed immigration documentation to a user; and
upon receiving approval from the user of the proposed immigration documentation, electronically tracking the proposed immigration documentation.

13. The method of claim 12, further comprising, before receiving approval from the user:
receiving an edit to the proposed immigration documentation;
revising the proposed immigration documentation based on the edit to yield revised immigration documentation; and
displaying the revised immigration documentation to the user.

14. The method of claim 13, further comprising updating a profile associated with at least one of the worker and the project based on the edit.

15. The method of claim 1, wherein electronically preparing and filing the immigration documentation further comprises:
receiving from the worker an electronic signature; and
applying the electronic signature to the immigration documentation.

16. The method of claim 1, further comprising:
recording a time stamp and a history of changes to the immigration documentation.

17. The method of claim 1, further comprising:
identifying an impending deadline associated with the immigration documentation; and
sending a notification reminder to a user of the impending deadline.

18. The method of claim 1, further comprising:
retrieving wage information for the worker while participating in the project; and
incorporating the wage information into the immigration documentation.

19. A system comprising:
a processor;
a network interface;
a memory storing instructions for controlling the processor to perform steps comprising:
identifying a project;
identifying a worker assigned to the project, wherein an immigration status of the worker requires the worker to have a visa to participate in the project;
electronically preparing and filing, through a connection to an immigration server established via the network interface, immigration documentation associated with the visa in order to allow the worker to participate in the project;
determining if an event occurs that impacts the immigration status; and
if the event occurs, updating the immigration documentation filed with the immigration server based on the event.

20. A non-transitory computer-readable storage medium storing instructions which, when executed by a computing device, cause the computing device to perform steps comprising:
identifying a project;
identifying, via a processor of a computing device, a worker assigned to the project, wherein an immigration status of the worker requires the worker to have a visa to participate in the project;
electronically preparing and filing immigration documentation associated with the visa in order to allow the worker to participate in the project;
determining if an event occurs that impacts the immigration status; and
if the event occurs, updating the immigration documentation based on the event.
